(19) United States
(12) Patent Application Publication
(10) Pub. No.: US 2023/0289864 A1
(43) Pub. Date: Sep. 14, 2023

(54) METHODS AND APPARATUS FOR DIFFUSED ITEM RECOMMENDATIONS

(71) Applicant: Walmart Apollo, LLC, Bentonville, AR (US)

(72) Inventors: Siddharth Pratap Singh, Fremont, CA (US); Chittaranjan Tripathy, Sunnyvale, CA (US); Sriram Krishnaswamy, Fremont, CA (US); Robert C. Potter, JR., Campbell, CA (US); Ioannis Pavlidis, Boulder, CO (US)

(21) Appl. No.: 18/018,774

(22) PCT Filed: Aug. 20, 2020
(86) PCT No.: PCT/US2020/047247

§ 371 Date: Jan. 30, 2023

(51) Int. Cl. G06Q 30/0601; G06Q 30/0251

(52) U.S. Cl. CPC G06Q 30/0631; G06Q 30/0256

(57) ABSTRACT

This application relates to apparatus and methods for providing recommended items to advertise. In some examples, a computing device determines a plurality of first values for a corresponding plurality of first items based on the user's engagement with each of the first items. The computing device may then determine a subset of the plurality of first items based on the first values. The computing device may receive a search request and determine a plurality of second values for a plurality of second items based on the search request. The computing device may determine a plurality of third values for the subset of items based on the plurality of second values for the plurality of second items and the user's engagement with each of the subset of items. The computing device may determine the recommended items based on the plurality of second values and the plurality of third values.

### TECHNICAL FIELD

The disclosure relates generally to digital advertisements and, more specifically, to electronically determining and providing item advertisement recommendations.

### BACKGROUND

At least some websites, such as retailer websites, allow a customer to enter a search query (e.g., via a search bar) to search for items sold on the website. In response, the retailer's website may provide search results that include displayed item advertisements. The item advertisements may include an image of an item, and a price of the item, for example. The item advertisements may be determined based on algorithms that operate on the search query provided by the customer. The website may further allow the customer to purchase the advertised items.

In some examples, however, the item advertisements are irrelevant to the customer. For example, a customer may not be interested in an advertised item and thus decide not to click on an item advertisement. For example, the customer may be searching for an item the customer previously purchased, and is instead presented with item advertisements of a different type of product. In some examples, out of stock items may cause irrelevant item advertisements to be displayed to the customer. For example, because an item is out of stock, current systems may display irrelevant item advertisements to the customer (e.g., item advertisements for items the customer is not interested in).

As a result, a retailer may lose sales of items to a customer. For example, the customer may not buy an item because it was not displayed in search results. In addition, the customer may leave the website without having purchased an item that, if shown an advertisement for, the customer would have purchased. In some examples, if a customer perceives an item advertisement as irrelevant, the customer may go elsewhere, such as another website, to purchase an item that is relevant to the customer. As such, there are opportunities to improve the determination and generation of item advertisements.

### SUMMARY

The embodiments described herein are directed to automatically determining and providing digital item advertisements that may be displayed, for example, on a website. The embodiments may allow a person, such as a customer, to be presented with advertisements of items (e.g., products and services) that may be more relevant to (e.g., likely to interest) the person. For example, the item advertisements may be displayed to the person in response to a search query provided by that person. The item advertisements may be for items that are of the same type as items previously purchased by that person. As an example, the embodiments may provide item advertisements for items of a same type that the person has previously purchased, such as item advertisements for different brands than a brand of an item the person previously purchased.

As used herein, diffusion refers to the inclusion of at least one different item (or item advertisement of an item) that is of a same (or similar) item type than that of an original item. For example, the embodiments may employ brand diffusion techniques to include at least one item (or item advertisement of an item) that is of a same (or similar) item type as that of the original item, but of a different brand. As an example, assume a user has previously purchased a “Brand-A” of penne pasta from a retailer's website, and subsequently visits the website and performs a search query for “penne pasta.” The embodiments described herein may generate an item advertisement for a “Brand-B” of penne pasta. As such, the embodiments may diffuse item advertisements of varying brands of penne pasta.

Among other advantages, the embodiments may allow customers to be presented with item advertisements for alternate, but similar, items. As a result, the embodiments may allow customers to be provided with additional purchase options for a type of item. In addition, the embodiments may allow customers to observe faster delivery times of purchased items (e.g., the customer may not have to wait until an original item is in stock) as well as lower costs (e.g., when an alternate item is of a lesser price than the original item, or to take advantage of additional discounts of a same item type from other brands).

Additionally, the embodiments may allow a retailer to increase sales that they would otherwise have not made without the benefits of the embodiments provided herein. For example, the customer may purchase from a retailer's website an alternate item that is of a same type of an original item (e.g., but different brand) that the customer has previously purchased when that original item is, for example, out of stock. As another example, the embodiments may allow for an increase in the number of relevant item advertisements displayed to customers, thereby reducing sales lost due to the display of irrelevant item advertisements. In some examples, the embodiments may increase a customer's trust of buying items available from different brands. Those of ordinary skill in the art may recognize additional benefits and advantages as well.

In accordance with various embodiments, exemplary systems may be implemented in any suitable hardware or hardware and software, such as in any suitable computing device. In some examples, a computing device determines a plurality of first values for a corresponding plurality of first items based on the user's engagement with each of the first items (e.g., the user's historical engagement with the first items). The computing device may determine the plurality of first values based on executing a first machine learning model (e.g., algorithm), such as the personal assortment set (PAS) model described herein, for example. The computing device may then determine a subset of the plurality of first items based on the first values. The computing device may receive a search request and determine a plurality of second values for a plurality of second items based on the search request. The computing device may determine a plurality of third values for the subset of items based on the plurality of second values for the plurality of second items and the user's engagement with each of the subset of items. The computing device may determine the plurality of third values based on executing a second machine learning model, such as the product searchability (PSE) model described herein, for example. The computing device may then determine the recommended items based on the plurality of second values and the plurality of third values. The computing device may determine the recommended items based on executing a third machine learning model, such as the brand diffusion (BD) model described herein, for example.

In some embodiments, a computing device is configured to receive a search request for a user. For example, the search request may be received from a web server that hosts a website, such as a retailer's website. The computing device is also configured to determine a plurality of first items based on the search request. Further, the computing device is configured to determine a first value for each of the plurality of first items based on a first portion of item engagement data identifying the user's engagement with each of the plurality of first items. In some examples, the computing device executes a PAS model to determine the first values. The computing device is also configured to determine, for at least a portion of the plurality of first items, a second value for each of a plurality of second items based on their corresponding first values and a second portion of the item engagement data identifying the user's engagement with the portion of the plurality of first items. In some examples, the computing device executes a PSE model to determine the second values. The computing device is further configured to determine a plurality of third items comprising at least a portion of the plurality of second items based on the first values and the second values. In some examples, the computing device executes a BD model to determine the plurality of third items. The computing device is also configured to transmit item recommendation data identifying the plurality of third items in response to the search request. For example, the computing device may transmit the item recommendation data to the web server hosting the website.

In some embodiments, a method is provided that includes receiving a search request for a user. The method also includes determining a plurality of first items based on the search request. Further, the method includes determining a first value for each of the plurality of first items based on a first portion of item engagement data identifying the user's engagement with each of the plurality of first items. In some examples, the method includes executing a PAS model to determine the first values. The method also includes determining, for at least a portion of the plurality of first items, a second value for each of a plurality of second items based on their corresponding first values and a second portion of the item engagement data identifying the user's engagement with the portion of the plurality of first items. In some examples, the method includes executing a PSE model to determine the second values. The method further includes determining a plurality of third items comprising at least a portion of the plurality of second items based on the first values and the second values. In some examples, the method includes executing a BD model to determine the plurality of third items. The method also includes transmitting item recommendation data identifying the plurality of third items in response to the search request.

In yet other embodiments, a non-transitory computer readable medium has instructions stored thereon, where the instructions, when executed by at least one processor, cause a computing device to perform operations that include receiving a search request for a user. The operations also include determining a plurality of first items based on the search request. Further, the operations include determining a first value for each of the plurality of first items based on a first portion of item engagement data identifying the user's engagement with each of the plurality of first items. In some examples, the operations include executing a PAS model to determine the first values. The operations also include determining, for at least a portion of the plurality of first items, a second value for each of a plurality of second items based on their corresponding first values and a second portion of the item engagement data identifying the user's engagement with the portion of the plurality of first items. In some examples, the operations include executing a PSE model to determine the second values. The operations further include determining a plurality of third items comprising at least a portion of the plurality of second items based on the first values and the second values. In some examples, the operations include executing a BD model to determine the plurality of third items. The operations also include transmitting item recommendation data identifying the plurality of third items in response to the search request.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item advertisement determination system that includes an item advertisement determination computing device in accordance with some embodiments;

FIG. 2 is a block diagram of the item advertisement determination computing device of FIG. 1 in accordance with some embodiments;

FIG. 3 is a block diagram illustrating examples of various portions of the item advertisement determination system of FIG. 1 in accordance with some embodiments;

FIG. 4A is a block diagram illustrating examples of various portions of the item advertisement determination computing device of FIG. 1 in accordance with some embodiments;

FIG. 4B is a block diagram illustrating examples of various portions of the item advertisement determination computing device of FIG. 1 in accordance with some embodiments;

FIG. 5 is a flowchart of an example method that can be carried out by the item advertisement determination computing device of FIG. 1 in accordance with some embodiments;

FIG. 6A is a flowchart of another example method that can be carried out by the item advertisement determination computing device of FIG. 1 in accordance with some embodiments; and

FIG. 6B is a flowchart of another example method that can be carried out by the item advertisement determination computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

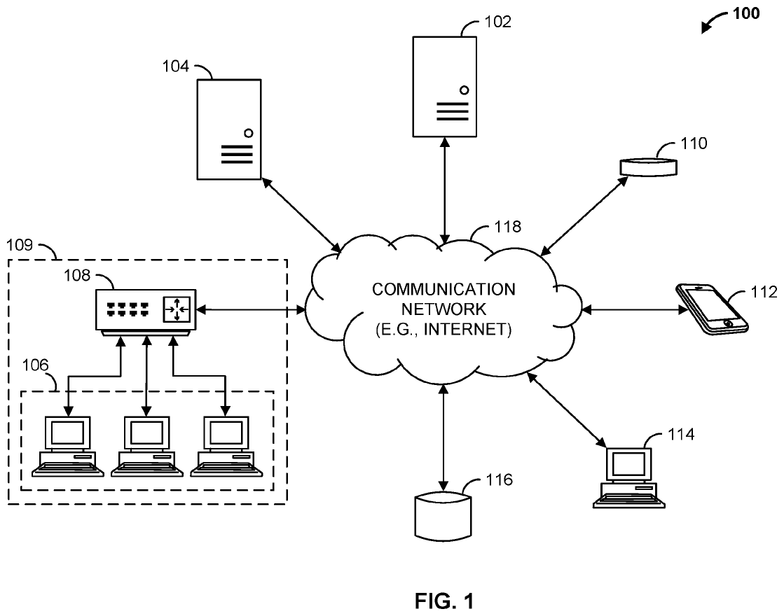

Turning to the drawings, FIG. 1 illustrates a block diagram of an item advertisement determination system 100 that includes an item advertisement determination computing device 102 (e.g., a server, such as an application server), a web server 104, workstation(s) 106, database 116, and multiple customer computing devices 110, 112, 114 operatively coupled over network 118. Item advertisement determination computing device 102, web server 104, workstation(s) 106, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, item advertisement determination computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, web server 104 hosts one or more retailer websites. In some examples, item advertisement determination computing device 102 and/or web server 104 are operated by a retailer, and multiple customer computing devices 112, 114 are operated by customers of the retailer.

Workstation(s) 106 are operably coupled to communication network 118 via router (or switch) 108. Workstation(s) 106 and/or router 108 may be located at a store 109, for example. Workstation(s) 106 can communicate with item advertisement determination computing device 102 over communication network 118. The workstation(s) 106 may send data to, and receive data from, item advertisement determination computing device 102. For example, the workstation(s) 106 may transmit data identifying items purchased by a customer at store 109 to item advertisement determination computing device 102.

Although FIG. 1 illustrates three customer computing devices 110, 112, 114, item advertisement determination system 100 can include any number of customer computing devices 110, 112, 114. Similarly, item advertisement determination system 100 can include any number of item advertisement determination computing devices 102, workstations 106, web servers 104, and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

In some examples, web server 104 hosts one or more web pages, such as a retailer's website. Web server 104 may transmit purchase data related to items purchased on the website by customers to item advertisement determination computing device 102 over communication network 118. In some examples, web server 104 may also transmit a search request to item advertisement determination computing device 102. The search request may identify a search query provided by a customer (e.g., within a search bar of the website). In response to the search request, item advertisement determination computing device 102 may execute one or more models (e.g., algorithms), such as a machine learning model, to determine items to advertise (e.g., item advertisements). Item advertisement determination computing device 102 may transmit the items to advertise to web server 104 over communication network 118. Web server 104 may then display item advertisements for the determined items to advertise as search results on the website to the customer. For example, the search results may be displayed on a search results webpage of the website in response to the search query entered by the customer.

First customer computing device 110, second customer computing device 112, and Nth customer computing device 114 may communicate with web server 104 over communication network 118. For example, each of multiple computing devices 110, 112, 114 may be operable to view, access, and interact with a website hosted by web server 104. In some examples, web server 104 hosts a website for a retailer that allows for the purchase of items. The website may further allow a customer to search for items on the website via, for example, a search bar. A customer operating one of multiple computing devices 110, 112, 114 may access the website and perform a search for items on the website by entering in one or more terms into the search bar. In response, the website may display search results that includes item advertisements, as described above and further herein. The website may allow the operator to add one or more of the items to an online shopping cart, and allow the customer to perform a “checkout” of the shopping cart to purchase the items.

Item advertisement determination computing device 102 is further operable to communicate with database 116 over communication network 118. For example, item advertisement determination computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item advertisement determination computing device 102, in some examples, database 116 can be a local storage device, such as a hard drive, a non-volatile memory, or a USB stick. Item advertisement determination computing device 102 may store purchase data received from web server 104 in database 116. The purchase data may identify purchase made by customers on a retailer's website hosted by web server 104, for example. Item advertisement determination computing device 102 may also receive from web server 104 user session data identifying events associated with browsing sessions, and may store the user session data in database 116.

In some examples, database 116 stores one or more executable models, such as executable machine learning models, that, when executed by item advertisement determination computing device 102, allow item advertisement determination computing device 102 to determine one or more items to advertise in response to a search query. For example, item advertisement determination computing device 102 may obtain the models from database 116. In response to receiving a search query received from web server 104, item advertisement determination computing device 102 may execute the obtained models to determine items to advertise. In some examples, two or more of the items may be of a same type, but of differing brands.

For example, to determine items to advertise to a customer, item advertisement determination computing device 102 may execute a personal assortment set (PAS) model to determine a customer's PAS (e.g., list of items associated with each customer). The PAS model may be a machine learning model. For example, the PAS model may be a binary-regression model such as a penalized-logistic regression model, a gradient boosting model, a random forest model, or a feed-forward neural network model. Item advertisement determination computing device 102 may execute the PAS model to generate PAS scores for one or more items in a supervised learning framework. The customer's PAS may include a ranking of items that the customer is likely to purchase. For example, the PAS score for each item in a customer's PAS may identify a likelihood that the customer will purchase the item in a given category (e.g., of a given item type). The PAS model may operate on features such as user session data (e.g., engagement data) for the customer to generate the PAS scores. The user session data for the customer may be received from web server 104 based on the customer's engagement with a retailer's website. For example, the user session data may identify, for the customer, item advertisement impressions, item advertisement clicks, item orders, recurring item purchase counts, item page viewing times, and other user session data. Execution of the PAS model may generate item scores (i.e., PAS scores) for each of the items based on corresponding user session data. For example, items that the customer has more often engaged with may be ranked ahead of items that the customer has engaged less with. In some examples, the PAS model applies a weight to each type of user session data, and thus the item score for each item is based on the user session data and corresponding weights (e.g., weighted user session data). In some examples, the weights may be determined by the machine learning model used to compute the PAS scores.

As an example, let x=(x_{purc}, x_{brws}, x_{cart}, xᵢₙₛₜₒᵣ) be a vector of covariates/traits of dimension d=d_{purc}+d_{brws}+d_{cart}+dᵢₙₛₜₒᵣ describing a customer at any point in time. Here, x_{purc} is the slice of the vector x of dimension d_{purc} representing the covariates for the customer's purchase history, x_{brws} is the slice of the vector x of dimension d_{brws} representing the covariates for the customer's browsing history, x_{cart} is the slice of the vector x of dimension d_{cart} representing the customer's cart (i.e., items to add to the customer's cart), dᵢₙₛₜₒᵣ is the slice of vector x of dimension dᵢₙₛₜₒᵣ representing the covariates of the customer's in-store purchase and time spent in-store (e.g., extracted from the data provided by a mobile device carried by a customer). It should be noted that in some embodiments more or less number of such covariates and the respective slices may be present.

The PAS model may be a supervised machine learning model that computes a probability score, PAS(x), given in some examples by, PAS(x)=Prob(B=1|X=x), where B is an indicator random variable indicating whether the customer purchased the item, such as within a previous amount of time (e.g., a week, a month, a year, etc.). For example, B may be a first value (e.g., 1) if the customer bought the item and another value (e.g., 0) if the customer did not buy the item. X may be a random vector of traits representing the customer through the observed traits x. The PAS algorithm may be implemented as a supervised machine learning model M. The supervised machine learning model M may be trained using N number of customer's traits represented by an N*d matrix and corresponding customer purchase (e.g., buys) Bi, where 1<=i<=N gives a N dimensional vector B of booleans. M learns the representation of the customers (e.g., in context to the each customer's traits and item context) and hence can predict the PAS score for each customer for each item using PAS(x)=M(x), which is nothing but the aforementioned probability score. Below is an exemplary model M that may be employed to compute probability scores. Model M is a logistic regression model, although other non-linear models as mentioned before can be used in other examples.

In a logistic regression model the PAS(x) for a customer represented by the vector of covariates where x is modeled using the equation:

$$log \frac{p ( x )}{1 - p ( x )} = {β}_{0} + {β}_{0} + {β}_{1} {x}_{1} + … + {β}_{d} {x}_{d} ,$$

Here, xᵢs for 1≤i≤d are for the customer traits in the vector x and βᵢs for 0≤23 i≤d are the coefficients of the logistic regression learned from the customer's traits. Below is the algorithm rewritten in terms of the probability score:

$$p ( x ) = \frac{1}{1 + exp ( - ( {β}_{0} + {β}_{1} {x}_{1} + … + {β}_{d} {x}_{d} ) )} ,$$

p(x)is the score that is returned by the model M for PAS(x). This algorithm to compute PAS(x) may return a ranked list of items, where the rank is based on the probability of the customer's purchase of the item/category.

Item advertisement determination computing device 102 may determine a threshold number of the items based on the ranking. The threshold may be dynamically determined for each customer to separate items based on their scores from PAS. For example, item advertisement determination computing device 102 may segregate each of the items into one of three categories: head, torso, and tail. Items with PAS item scores at or above a first threshold (e.g., 75 on a scale of 0 to 100, or item lying in a fourth quantile of the score from PAS) may be placed into the head category, items with PAS item scores below a second threshold (e.g., 25 on the scale of 0 to 100) may be placed into the tail category, and items with PAS item scores at or above the second threshold and below the first threshold may be placed into the torso category.

In some examples, the items associated with the head category correspond to “regularly used” items, while the items associated with the torso category correspond to “intermittently used” items and the items associated with the tail category correspond to “rarely used” items. Item advertisement determination computing device 102 may then determine the number of items in one or more of the categories. For example, item advertisement determination computing device 102 may determine the number of items in each of the torso (e.g., “rarely used”) and tail (e.g., “intermittently used”) categories. In some examples, item advertisements for items that correspond to the “head” category are not diffused, as the customer has a high affinity with the particular item (e.g., of a particular brand).

For each of the number of items determined (e.g., in one or more of the above categories, such as in torso and tail categories), item advertisement determination computing device 102 may execute a Product Searchability (PSE) model to generate a PSE score for a given search query (e.g., a search query provided by the user to a website hosted by web server 104). The PSE score may identify a “purchase likelihood” by each customer for each item for the given search query. For example, the PSE score may be indicative of a “variation” of the likelihood the item may be purchased by the customer given the search query. This variation may be inversely proportional to a confidence of the customer purchasing the item. For example, the higher the PSE score (e.g., the higher the variation), the less likely the customer may purchase the item (e.g., the exact item, and not a substitute item).

As an example, given a query q and an item x, an algorithm defined by PSE(q, x) may return a ranked list of items, where the rank is based on a probability of purchase of the item/category.

The PSE model may be a machine learning model that operates on features such as user session data for the customer. For example, the PSE model may be a binary-regression model such as a penalized-logistic regression model, a gradient boosting model, a random forest model, or a feed-forward neural network model. The PSE model may use a query term q to make a prediction. The PSE score is defined as the conditional probability of buying B=1 given q and x, that is, PSE(q, x)=Pr(B=1|Q=q, X=x), where Q is a random vector representing the query and X is a random vector representing the customer's traits. In other words, the PSE model may generate a purchase affinity score for a product given a query. Item advertisement determination computing device 102 may execute the PSE model in a supervised learning framework to generate the PSE scores. For each item, item advertisement determination computing device 102 may execute the PSE model to operate on user session data for a customer based on when that customer purchased (e.g., first purchased) that item. The user session data may include query intent data (e.g., data identifying an item type based on a search query), number of queries issued, items explored (e.g., viewed), time taken between searches, items added to cart (ATC), item orders, click rates, order rates, average products screened before click, average products screened before a purchase order, average purchase amounts per month, average number of units bought per order, and item advertisement impressions. In some examples, the user session data for each item may include only user session data that occurred up to the time that the customer first purchased the item.

As an example, assume a customer recurrently purchases a type of hair oil from a website hosted by web server 104. Before the customer first purchased the hair oil from the website, the customer may have entered a search query to the website, and may have browsed one or more item advertisements, or one or more item detail pages, of the website based on search results that were provide in response to the search query. The item advertisements and/or item detail pages may have included various products, such as various hair products. A PSE score for the hair oil as generated by item advertisement determination computing device 102 may be based, for example, on one or more of the following: a time spent between entering the search query and making the first purchase; a number of items viewed before purchasing the item; a type of items viewed (e.g., content); a buying likelihood of the item (e.g., a local likelihood based on item purchase likelihood models); and a number of search queries entered by the customer that “match” a hair oil intent (e.g., as determined by matching models). As such, while the PAS model matches and ranks customers to products, the PSE provides insights for products at a query level. In some examples, PAS is an offline model while PSE is a model that takes a present user query to calculate the scores for the products.

In some examples, after a PSE score is determined for an item (e.g., original item), item advertisement determination computing device 102 determines similar items (e.g., of a same item type, but different brand) to advertise to the customer. To determine the similar items, item advertisement determination computing device 102 executes a diffused exploration (DE) model that operates on the PAS and PSE scores. For example, the DE Model identifies items for advertising based on a combination of the PAS scores and the PES scores. As a result, the DE model may identify items of similar products but of alternative brands and/or items of varying products.

In some examples the DE model may be a diffusion framework that, for each item, identifies similar items from different brands that may interest the customer (e.g., as a substitute for the original item). The DE model may operate on a similarity of the original item to each of the similar items (e.g., as given by a similarity score). For example, the DE model may include a machine learning model that determines similarity scores based on the similarity of corresponding item descriptions, whether the items are typically purchased together, similarity between search query terms and item descriptions, etc. In some examples, the DE model also operates on one or more of a popularity score, a trending score, a verifiability score, or a visibility score (e.g., how often a customer viewed an item) for each of the similar items. Each of these scores may be generated by models, such as machine learning models, that are designed to generate their respective scores as known in the art.

In some examples, the DE model weighs (e.g., boosts, or buries) an item visibility score based on a corresponding PSE score to an item. For example, the higher the PSE score, the lower the item visibility score is weighted. Likewise, the lower the PSE score, the higher the item visibility score is weighted. As an example, the item visibility scores may be weighted based on normalizing the PSE scores, and adjusting the item visibility scores based on a multiplication factor (e.g., 1.1) applied to the normalized PSE score.

Item advertisement determination computing device 102 may then identify a plurality of items to advertise, which may include one or more of the substituted items, and provide them for advertisement on a website. The items to advertise may be identified using a rank-based static method, or a multi-armed bandit (MAB) framework, for example. Item advertisement determination computing device 102 may then provide the identified items for advertising.

For example, item advertisement determination computing device 102 may receive a search query provided by a customer browsing a retailer's website hosted by web server 104. In response, item advertisement determination computing device 102 may execute the PAS model, the PSE model, and the DE model for the customer, and provide identified items to advertise. Web server 104 may then display item advertisements for the identified items to the customer (e.g., as the customer browses the website).

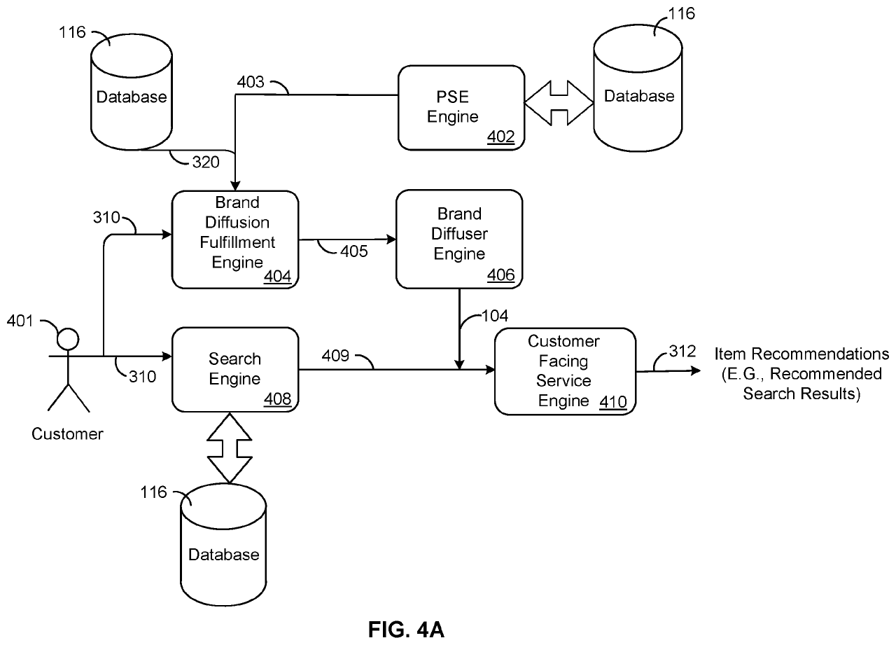

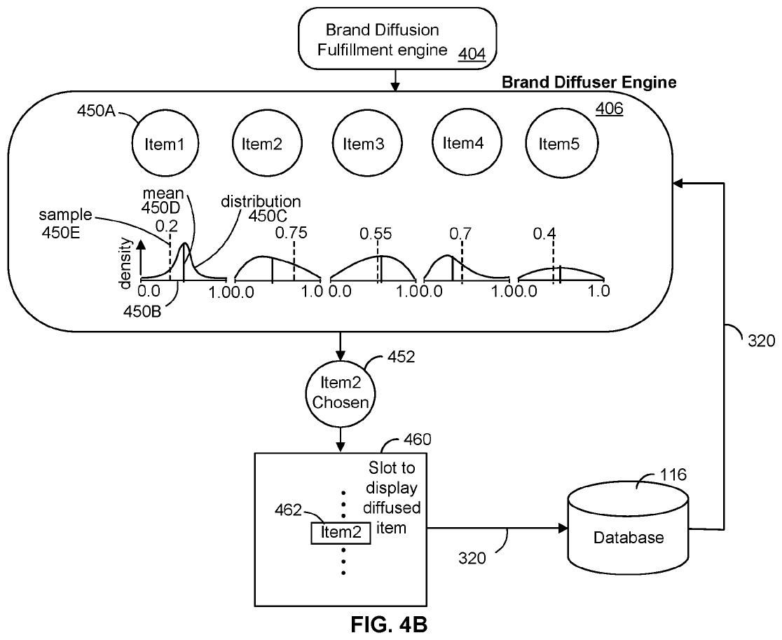

In some examples, the DE model performs the following steps. First, the DE model identifies similar products from different brands that may be probable candidates for a customer (or similar customers). The probable candidates may be determined based on products the customer has purchased and the similarity of products and the popularity/trending/verifiability scores of an alternative product. Second, the DE model may explore the product's purchase likelihood for the customer using one or more of known visibility methods (e.g., algorithms) available for eCommerce. Third, the DE model may boost/bury item visibility across other users based on the analysis of the exploration results, a component of which may be the PSE score. Item advertisements for the diffused brands may then be served to the customer in a usual rank-based static mechanism or can be served using, for example, a multi-armed bandit (MAB) framework in order to adaptively learn and estimate individual customer's brand preferences and diffusivity (how open they are to accept an alternate brand). This is explained further below with respect to FIG. 4B.

In some examples, user session data may not be available for a particular customer (e.g., a guest customer). To address this cold start problem, in such examples, rather than relying on PAS or PSE scores, the DE model operates on global data, such as data that identifies best-selling items, on-sale items, currently trending items, geographic and/or seasonal sale items, for example. In other words, for each item, a list of similar items is generated based on this global data (e.g., without personalization). In some examples, an MAB-based exploration-exploitation approach is employed.

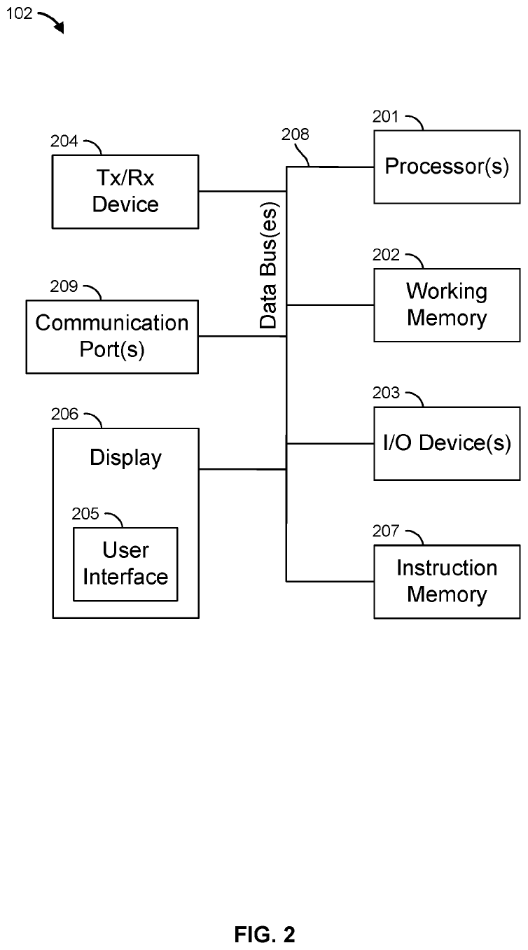

FIG. 2 illustrates the item advertisement determination computing device 102 of FIG. 1. Item advertisement determination computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 207, embodying the function or operation. For example, processors 201 can be configured to execute code stored in instruction memory 207 to perform one or more of any function, method, or operation disclosed herein.

Additionally processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item advertisement determination computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning model training data.

Display 206 can display user interface 205. User interfaces 205 can enable user interaction with item advertisement determination computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item advertisement determination computing device 102 will be operating in. Processor(s) 201 is operable to receive data from, or send data to, a network, such as communication network 118 of FIG. 1, via transceiver 204.

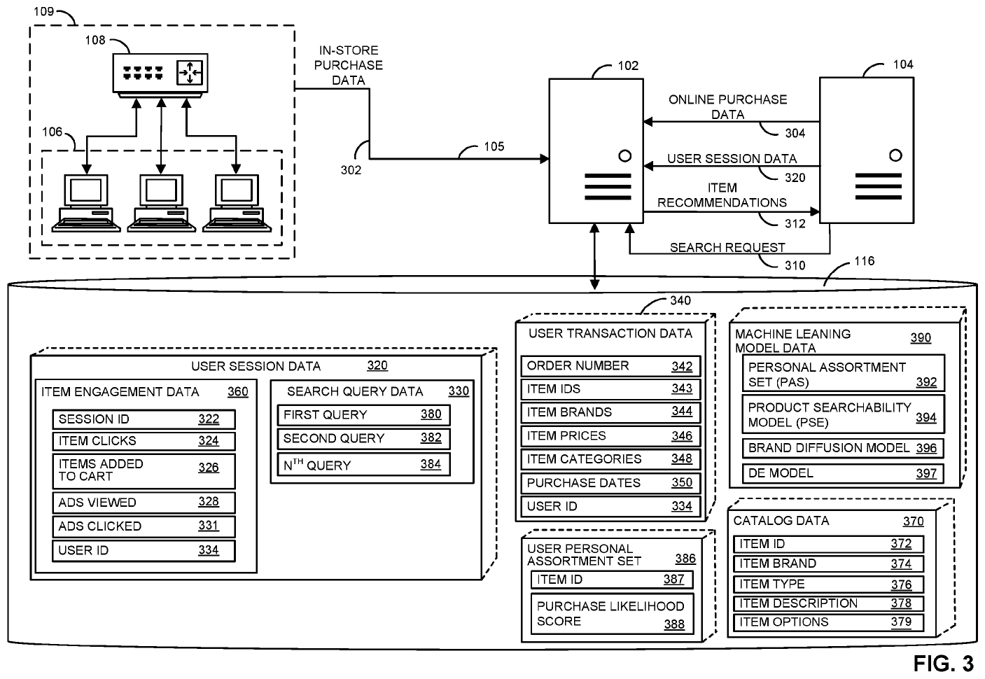

FIG. 3 is a block diagram illustrating examples of various portions of the item advertisement determination system 100 of FIG. 1. As indicated in the figure, item advertisement determination computing device 102 may receive user session data 320 from web server 104, and store user session data 320 in database 116. User session data 320 may identify, for each user (e.g., customer), data related to a browsing session, such as when browsing a retailer's webpage hosted by web server 104. In this example, user session data 320 includes item engagement data 360 and search query data 330. Item engagement data 360 may include one or more of a session ID 322 (i.e., a website browsing session identifier), item clicks 324 identifying items which the user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 ID (e.g., a customer ID, retailer website login ID, etc.). Search query data 330 may identify one or more searches conducted by a user during a browsing session (e.g., a current browsing session). In this example, search query data 330 includes first query 380, second query 382, and Nth query 384.

Item advertisement determination computing device 102 may also receive online purchase data 304 from web server 104, which identifies and characterizes one or more online purchases, such as purchases made by the user via a retailer's website hosted by web server 104. Item advertisement determination computing device 102 may also receive in-store purchase data 302 from store 109, which identifies and characterizes one or more in-store purchases.

Item advertisement determination computing device 102 may parse in-store purchase data 302 and online purchase data 304 to generate user transaction data 340. In this example, user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item types 348 identifying a type (e.g., category) of each item purchased, a purchase date 350 identifying the purchase date of the purchase order, and user ID 334 for the user making the corresponding purchase.

Database 116 may further store catalog data 370, which may identify one or more attributes of a plurality of items, such as a portion of or all items a retailer carries. Catalog data 370 may identify, for each of the plurality of items, an item ID 372 (e.g., an SKU number), item brand 374, item type 376 (e.g., grocery item such as milk, clothing item), item description 378 (e.g., a description of the product including product features, such as ingredients, benefits, use or consumption instructions, or any other suitable description), and item options 379 (e.g., item colors, sizes, flavors, etc.).

Database 116 may also store machine learning model data 390 identifying and characterizing one or more machine learning models. For example, machine learning model data 390 may include personal assortment set (PAS) model 392, product searchability (PSE) model 394, brand diffusion (BD) model 396, and diffused exploration (DE) model 397. Database 116 may further store training data used to train each of PAS model 392, PSE model 394, BD model 396, and, in some examples, DE model 397.

Item advertisement determination computing device 102 may obtain and execute one or more of PAS model 392, PSE model 394, BD model 396, and DE model 397 to generate item recommendations 312 in response to a search query 310 received from web server 104. For example, a customer browsing a website hosted by web server 104 may enter one or more search terms (e.g., via a search box) into the website. In response, web server 104 may generate search query 310 identifying and characterizing the search terms, and transmit search query 310 to item advertisement determination computing device 102. Item advertisement determination computing device 102 may then determine one or more items to advertise based on executing PAS model 392, PSE model 394, and BD model 396. Item advertisement determination computing device 102 may generate recommended items 312 identifying and characterizing the items to advertise, and may transmit recommended items 312 to web server 104. Web server 104 may then display advertisements for the recommended items 312 on the website to the customer.

In some examples, item advertisement determination computing device 102 obtains PAS model 392 from database 116 and generates PAS scores for a plurality of items for a customer based on executing PAS model 392. For example, for each customer identified by a user ID 334, item advertisement determination computing device 102 may execute PAS model 392 based on item engagement data 360 for each of a plurality of items corresponding to that customer to generate a PAS score 388 for each item. Each PAS score 388 may identify a likelihood that the customer will purchase the item in a given category. For each customer, item advertisement determination computing device 102 may identify items within the customer's PAS with a PAS score 388 below a threshold (e.g., threshold associated with the head category), and may generate a personal assortment set (PAS) 386 identifies each item's item ID 387 and corresponding PAS score 388. Item advertisement determination computing device 102 may store PAS score 388 in database 116. In some examples, a customer's PAS score 388 is generated periodically (e.g., weekly, monthly, etc.). In some examples, a customer's PAS score 388 is generated upon receiving a search request 310 from web server 104.

Item advertisement determination computing device 102 may also obtain PSE model 394 from database 116 and execute PSE model 394 to generate one or more PSE scores associated with one or more items for the customer based on search request 310. Each PSE score may identify a likelihood that the customer will purchase the item based on search request 310. For example, search request 310 may identify a customer via a user ID 334 and a search query. Item advertisement determination computing device 102 may execute a search model to determine one or more original items to advertise to the customer. In some examples, the search model operates on user session data 320 for the customer (e.g., based on user ID 334). The search model may be one known in the art. Item advertisement determination computing device 102 may then identify the PAS scores 388 for the original items as well as the user session data 320 associated with each of the original items, and provide the PAS scores 388 and user session data 320 for the original items to PSE model 394 for execution to generate the PSE scores. The PSE scores may identify a variation in a likelihood the customer may buy each corresponding item.

Item advertisement determination computing device 102 may then determine a diffused set of item recommendations 312 to advertise based on the PAS scores 388 and the generated PSE scores. For example, item advertisement determination computing device 102 may obtain BD model 396 from database 116. Item advertisement determination computing device 102 may provide to the PSE model 394 the original items (e.g., item IDs 387) as determined by the search model, the user session data 320 for the customer, the search query, the generated PAS scores 388, the generated PSE scores, and catalog data 370 for execution. Item advertisement determination computing device 102 may execute the BD model 396 to identify substitute items to advertise to the customer. For example, execution of BD model 396 may identify, for each original item (e.g., as determined by the search model), similar items (e.g., of a different brand) that may be advertised to the customer. For example, each original item and corresponding similar items may be associated with the same item type 376, but be of different brands (e.g., and thus different item IDs 372). Execution of BD model 396 may further rank the original items and substitute items. Item advertisement determination computing device 102 may generate item recommendations 312 identifying and characterizing the ranked items to advertise, and may transmit item recommendations 312 to web server 104. Web server 104 may then display advertisements for the items as identified by item recommendations 312.

FIG. 4A illustrates exemplary portions of the item advertisement determination computing device 102 of FIG. 1. Specifically, FIG. 4A illustrates PSE engine 402, BD Fulfillment engine 404, BD engine 406, search engine 408, and customer facing service engine 410. In some examples, one or more of PSE engine 402, BD Fulfillment engine 404, BD engine 406, search engine 408, and customer facing service engine 410 may be implemented in hardware. In some examples, one or more of PSE engine 402, BD Fulfillment engine 404, BD engine 406, search engine 408, and customer facing service engine 410 may be as an executable program maintained in a tangible, non-transitory memory, such as instruction memory 207 of FIG. 2, that may be executed by one or processors, such as processor 201 of FIG. 2.

In this example, item advertisement determination computing device 102 receives (e.g., from web server 104) a search request 310 provided by a customer 401. The search request is provided to search engine 408 and BD fulfillment engine 404. Search engine 408 generates original item scores 409 identifying and characterizing items for advertisement based on search request 310. For example, search engine 408 may execute a search model to identify the original items based on a search query. The search model may be one as known in the art.

BD fulfillment engine 404 may obtain user session data 320 associated with a plurality of items from database 116, and may execute a PAS model, such as PAS model 392, that operates on the user session data 320 to generate a PAS score 388 for customer 401. For example, BD fulfillment engine 404 may obtain user session data 320 for the customer 401 associated with one or more items identified by search engine 408 (e.g., original items), and may generate PAS scores 388 for those items. BD fulfillment engine 404 may also obtain PSE scores 403 from PSE engine 402. PSE engine 402 may generate the PSE scores 403 by executing a PSE model, such as PSE model 394, that operates on user session data 320 for the customer 401, which may include search query data 330 for the customer 401.

Based on the generated PAS scores 388 and/or PSE scores 403, BD fulfillment engine 404 may determine a diffusible item score 405 associated with a degree as to how much item advertisements for items determined by search engine 408 (original items) may be diffused (e.g., whether advertisements for item substitutions should be provided). For example, item advertisements for original items with PAS scores 388 at or above a first threshold (e.g., items determined to be in a “head” category) may not be diffused at all, while item advertisements for original items with PAS scores below the first threshold may be diffused. Additionally or alternatively, in some examples, item advertisements for original items with PSE scores below a second threshold (e.g., items considered to have a high affinity to the customer) may not be diffused, while item advertisements for original items with PSE scores at or above the second threshold may be diffused. In some examples, BD fulfillment engine 404 determines whether item advertisements for original items are to be diffused based on one or more algorithms that operate on PAS scores 388 and PSE scores 403. BD fulfillment engine 404 provides diffusible item scores 405 to BD engine 406.

BD engine 406 obtains diffusible item scores 405 and normalizes them to original item scores 409. For example, BD engine 406 may normalize item scores 405 such that they are on a same scale as item scores 409. BD engine 406 may apply any known normalization technique as known in the art. BD engine 406 generates normalized diffusible item scores 407 identifying and characterizing the normalized scores, and provides normalized diffusible item scores 407 to customer facing service engine .

Customer facing service engine 410 obtains normalized diffusible item scores 407 and original item scores 409 to determine a blending of items to advertise. For example, BD engine 406 may determine a ranking of items based on the normalized diffusible item scores 407 and original item scores 409. As a result, the ranking of items may include items of similar products but of alternative brands, as well as items of varying products.

In some examples, customer facing service engine 410 implements a rank-base static model or a reinforced learning based multi-armed bandit (MAB) framework to determine the ranking. Customer facing service engine 410 generates item recommendations 312 identifying and characterizing the ranking. If, for example, an item is not diffusible (e.g., a diffusible item scores 405 of 0), item recommendations 312 may be based solely on original item scores 409. Customer facing service engine 410 may provide item recommendations 312 to a server, such as web server 104, to display item advertisements for the items identified by item recommendations 312. In some examples, item recommendations 312 identify one or more item IDs 372.

FIG. 4 B illustrates an example of BD engine 406 determine an item from a plurality of items to display to a customer. In this example, BD engine 406 receives a plurality of items 450A from BD fulfillment engine 404 for a user browsing a website, for example. Specifically, BD fulfillment engine 404 generates five items 450A that may be similar to each other but are of different brands to be diffused to a customer. Each item 450A has a success probability that is a probability of being clicked or added to an online shopping cart, as illustrated by corresponding probability distributions 450B. Each probability distribution 450B indicates a distribution 450C, a mean value 450D, and a sampled value 450E.

Each distribution 450B represents the distributional density of clicks. In some examples, this distributional density of clicks can be modeled as a (β-distribution with success being a total count of clicks (S) and failure being a total count of instances when the item was displayed but not clicked (F). If the total number of displays/impressions is N, then N=S+F. And the mean of the beta distribution may be determined according to S/N. Each item, therefore, is represented by a (β-distribution, and is otherwise termed as represented by an arm of a multi-armed bandit (MAB).

To display an item in a particular slot 462 of a search result presentation page 460 (e.g., as displayed on display 206), BD engine 406 determines an item using an explore-exploit method that, in this example, uses Thompson's sampling. For example, if a greedy approach is employed, the mean of each of the distributions 450B may be used to determine the item, which in this example would be Item 1, as it has the highest mean value among the plurality of items 450A. This is pure exploitation, since the item chosen has the highest probability, in a greedy fashion.

The exploration-exploitation mechanism of MAB, however, samples each of these distributions. A sampling of a distribution has higher probability of returning a value where density is concentrated (e.g., around the mean values). Because it is a sampling process, there is a possibility that a sample is selected from low density regions of the distributions 450B. For example, in this example, Item 2 has a highest sampled value 470 (i.e., 0.75 compared to the other sampled values). Execution of the MAB chooses this item for presentation in the search result display slot 462 of search result presentation page 460.

Once the item is chosen by the MAB and displayed in the search result presentation page 460, the customer may or may not click and/or add the item to their cart. This information is provided as user session data 320, and is stored in database 116 as attributes of the customer. The information may also be used to update the respective probability distribution 450B of the item, which is provided to BD engine 406. This mechanism is interactive and feed-back based and the updates can be done in real time.

Further, in some examples, the customer's feedback (e.g., click/add-to-cart) can be delayed, and the MAB mechanism accounts for that. Furthermore, the MAB mechanism may implement a scheme to discount past activity and give more weight to more recent interactions. This mechanism may allow for forgetting the distant past (e.g., based on a threshold amount of time). Such a mechanism helps with automatically picking trends and short-lived spikes in item demands in a dynamic world of product suggestions through brand diffusion against user queries.

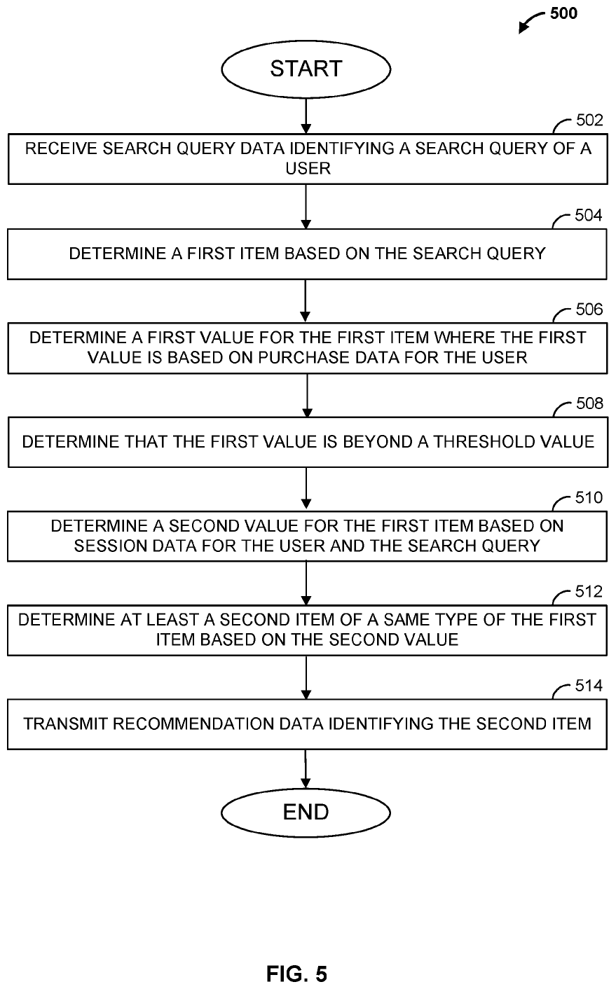

FIG. 5 is a flowchart of an example method 500 that can be carried out by a computing device, such as the item advertisement determination computing device 102 of FIG. 1. Beginning at step 502, search query data identifying a search query of a user is received. For example, item advertisement determination computing device 102 may receive a search request 310 from web server 104 identifying one or more search terms. At step 504, a first item is determined based on the search query. For example, item advertisement determination computing device 102 (e.g., via search engine 408) may generate an item score 409 for an item based on the search terms of search request 310.

Proceeding to step 506, a first value for the first item is determined. The first value is based on purchase data for the user. For example, item advertisement determination computing device 102 may execute a PAS model, such as PAS model 392, to determine a PAS score for the first item. At step 508, a determination is made that the first value is beyond a threshold value. For example, item advertisement determination computing device 102 may determine that the PAS score is below a threshold (e.g., and thus in a “torso” or “tail” category). The PAS score may indicate a probability that the user may purchase the first item.

At step 510, a second value for the first item is determined based on session data for the user and the search query. For example, item advertisement determination computing device 102 may execute a PSE model, such as PSE model 394, to determine a PSE score for the first item. The PES model 394 may operate on user session data 320 for the user and the search request 310. The PES score may indicate a probability that the user may purchase the first item given the search query.

Proceeding to step 512, at least a second item of a same type of the first item is determined based on the second value. For example, item advertisement determination computing device 102 may execute a BD model, such as BD model 396, to identify one or more items of varying brands that are of the same item type (e.g., item type 376) as the first item. At step 514, recommendation data identifying the second item is transmitted. For example, item advertisement determination computing device 102 may transmit item recommendations 312 to web server 104, where the item recommendations 312 identify at least the second item. Web server 104 may then display item advertisements for the second item to the user based on receiving the recommendation data. The method then ends.

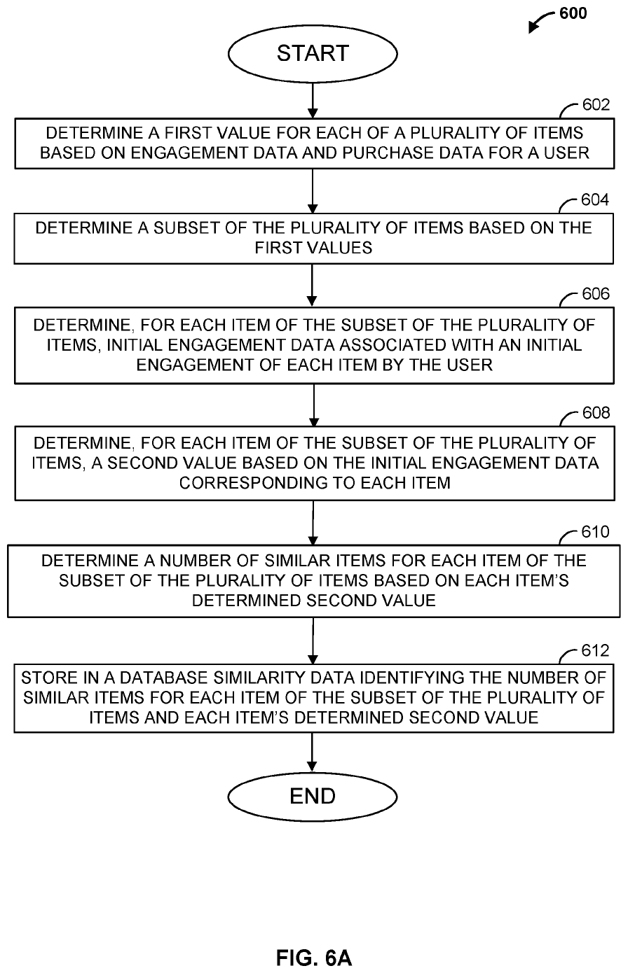

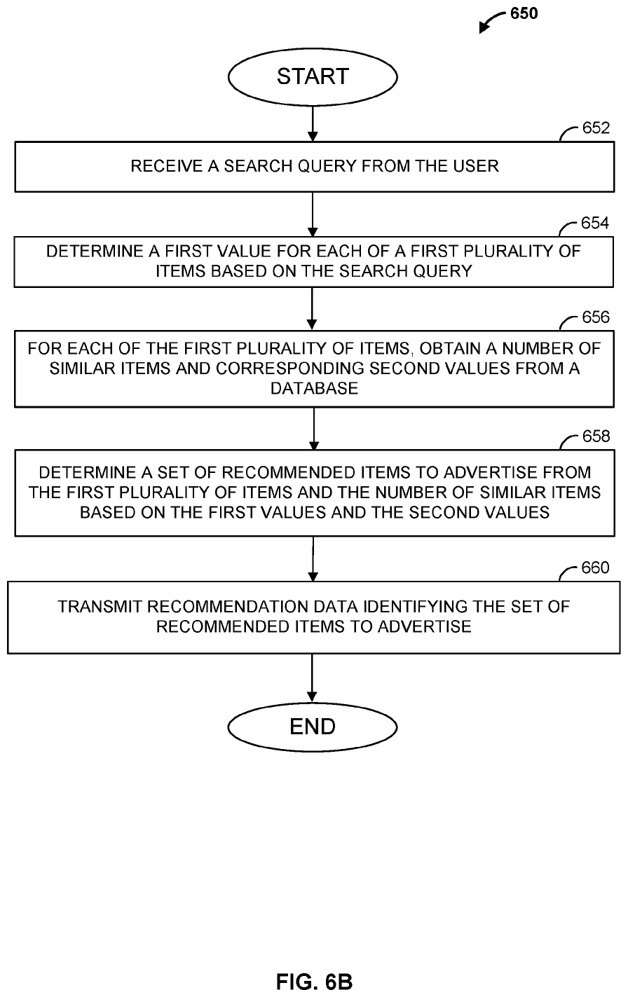

FIG. 6A is a flowchart of an example method 600 that can be carried out by a computing device, such as the item advertisement determination computing device 102 of FIG. 1. The method may be carried out occasionally, such as periodically (e.g., nightly, weekly, monthly), for example.

Beginning at step 602, a first value is determined for each of a plurality of items based on engagement data and purchase data for a user. For example, item advertisement determination computing device 102 may execute a PAS model, such as PAS model 392, to determine a PAS score for each of the plurality of items based on item engagement data 360 and user transaction data 340 for the user. At step 604, a subset of the items may be determined based on the first values. For example, item advertisement determination computing device 102 may determine the items out of the plurality of items with a first value (e.g., PAS score) below a threshold (e.g., below a threshold associated with a “head” category).

Proceeding to step 606, for each of the subset of items, initial engagement data is determined. The initial engagement data is associated with an initial engagement of each item by the user. For example, item advertisement determination computing device 102 may determine, for each item, item engagement data 360 for the user that occurred up to the time that the user first purchased each item. At step 608, for each of the subset of items, a second value is determined based on the initial engagement data corresponding to each item. For example, item advertisement determination computing device 102 may execute a PSE model, such as PSE model 394, to determine a PSE score for each of the subset of items. The PSE model may operate on the initial engagement data corresponding to each item to generate the PSE scores.

At step 610, a number of similar items for each item of the subset of items are determined based on the second values. For example, item advertisement determination computing device 102 may execute a BD model, such as BD model 396, to identify the number of similar items. The BD model 396 may operate on the second values to determine the similar items. At step 612, similarity data identifying the similar items and their corresponding second values are stored in a database, such as database 116. The similar items may be of a same item type, but of a different brand, of the corresponding item of the subset of items. The method then ends.

FIG. 6B is a flowchart of an example method 650 that can be carried out by a computing device, such as the item advertisement determination computing device 102 of FIG. 1. Beginning at step 652, a search query from a user is received. For example, item advertisement determination computing device 102 may receive a search request 310 from web server 104. The search request 310 may identify one or more search terms for a user that provided the search terms via a website that web server 104 hosts. At step 654, a first value for each of a plurality of items are determined based on the search query. For example, item advertisement determination computing device 102 (e.g., via search engine 408) may execute a search algorithm that operates on the search query to identify the plurality of items (e.g., original items).

Proceeding to step 656, for each of the first plurality of items, a number of similar items and corresponding second values are obtained from a database. For example, item advertisement determination computing device 102 may determine, for each of the plurality items, corresponding similar items (and their corresponding values) that are stored in database 116. The similar items (e.g., substitute items) and corresponding values may have been previously stored in database 116 in accordance with method 600 of FIG. 6A, for example. The similar items may be of a same item type of each original item, but of a different brand.

At step 658, a set of recommended items to advertise is determined from the first plurality of items and the number of similar items based on the first values and the second values. For example, item advertisement determination computing device 102 may execute a BD model, such as BD model 396, that operates on the first values and the second values to identify which of the first plurality of items and the number of similar items include in the set of recommended items to advertise to the user. The method then proceeds to step 660, where recommendation data identifying the set of recommended items to advertise is transmitted. For example, item advertisement determination computing device 102 may transmit item recommendations 312 to web server 104 that includes the recommendation data to web server 104. Web server 104 may then display item advertisements for the items identified by the recommendation data to the user. For example, the item advertisements may be displayed to the user on a search results page in response to the user entering the search query. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

1. A system comprising:
a computing device configured to:
receive a search request for a user;
determine a plurality of first items based on the search request;
determine a first value for each of the plurality of first items based on a first portion of item engagement data identifying the user's engagement with each of the plurality of first items;
determine, for at least a portion of the plurality of first items, a second value for each of a plurality of second items based on their corresponding first values and a second portion of the item engagement data identifying the user's engagement with the portion of the plurality of first items;
determine a plurality of third items comprising at least a portion of the plurality of second items based on the first values and the second values; and
transmit item recommendation data identifying the plurality of third items in response to the search request.

2. The system of claim 1, wherein at least a portion of the plurality of second items are of a same item type as their corresponding first item of the plurality of first items.

3. The system of claim 2, wherein the portion of the plurality of second items are of a different brand as their corresponding first item of the plurality of first items.

4. The system of claim 1, wherein the first value for each of the plurality of first items is determined further based on user transaction data for the user.

5. The system of claim 1, wherein the first value for each of the plurality of first items is determined by executing a personal assortment set (PAS) model that operates on the first portion of the item engagement data identifying the user's engagement with each of the plurality of first items.

6. The system of claim 5, wherein the first portion of the item engagement data comprises at least one of: item advertisement impressions or item advertisement clicks.

7. The system of claim 5, wherein the PAS model comprises a binary-regression model.

8. The system of claim 1, wherein the second value for each of the plurality of second items is determined by executing a product searchability (PSE) model that operates on the corresponding first values and the second portion of the item engagement data identifying the user's engagement with the portion of the plurality of first items.

9. The system of claim 8, wherein the second portion of the item engagement data comprises a period of time between when the user entered a search query and when the user purchased the portion of the plurality of first items.

10. The system of claim 8, wherein the PSE model comprises a binary-regression model.

11. The system of claim 1, wherein the plurality of third items is determined by executing a brand diffusion (BD) model that operates on the first values and the second values.

12. A method comprising:
receiving a search request for a user;
determining a plurality of first items based on the search request;
determining a first value for each of the plurality of first items based on a first portion of item engagement data identifying the user's engagement with each of the plurality of first items;
determining, for at least a portion of the plurality of first items, a second value for each of a plurality of second items based on their corresponding first values and a second portion of the item engagement data identifying the user's engagement with the portion of the plurality of first items;
determining a plurality of third items comprising at least a portion of the plurality of second items based on the first values and the second values; and
transmitting item recommendation data identifying the plurality of third items in response to the search request.

13. The method of claim 12, wherein at least a portion of the plurality of second items are of a same item type as their corresponding first item of the plurality of first items.

14. The method of claim 13, wherein the portion of the plurality of second items are of a different brand as their corresponding first item of the plurality of first items.

15. The method of claim 12, wherein determining the first value for each of the plurality of first items comprises executing a personal assortment set (PAS) model that operates on the first portion of the item engagement data identifying the user's engagement with each of the plurality of first items.

16. The method of claim 12, wherein determining the second value for each of the plurality of second items comprises executing a product searchability (P SE) model that operates on the corresponding first values and the second portion of the item engagement data identifying the user's engagement with the portion of the plurality of first items.

17. The method of claim 12, wherein determining the plurality of third items comprises executing a brand diffusion (BD) model that operates on the first values and the second values.

18. A non-transitory computer readable medium having instructions stored thereon, wherein the instructions, when executed by at least one processor, cause a device to perform operations comprising:
receiving a search request for a user;
determining a plurality of first items based on the search request;
determining a first value for each of the plurality of first items based on a first portion of item engagement data identifying the user's engagement with each of the plurality of first items;
determining, for at least a portion of the plurality of first items, a second value for each of a plurality of second items based on their corresponding first values and a second portion of the item engagement data identifying the user's engagement with the portion of the plurality of first items;
determining a plurality of third items comprising at least a portion of the plurality of second items based on the first values and the second values; and
transmitting item recommendation data identifying the plurality of third items in response to the search request.

19. The non-transitory computer readable medium of claim 18, wherein at least a portion of the plurality of second items are of a same item type as their corresponding first item of the plurality of first items.

20. The non-transitory computer readable medium of claim 19, wherein the portion of the plurality of second items are of a different brand as their corresponding first item of the plurality of first items.
